(19) United States
(12) Patent Application Publication
(10) Pub. No.: US 2010/0294088 A1
(43) Pub. Date: Nov. 25, 2010

(54) Adjustable spanner

(76) Inventors: Gwo Jong Jeng, Taichung City (TW); Kuan Jung Liu, Chia Yi Hsien (TW); Yen Chun Heng, Taichung City (TW); Chung Pang Heng, Taichung City (TW)

Correspondence Address: Wang Law Firm, Inc., 4989 Peachtree Parkway,, Suite 200, Norcross, GA, 30092, US

(21) Appl. No.: 11/902,521

(22) Filed: Sep. 21, 2007

(51) Int. Cl. B25B 13/12

(52) U.S. Cl. 81/176.3

(57) ABSTRACT

An adjustable spanner includes a head containing a fixed jaw and a movable jaw; a slide is disposed at bottom of the fixed jaw, and an accommodation trough is disposed in the head; the movable jaw contains an insertion edge corresponding to the slide and tapered surface is disposed on bottom of the insertion edge; a locating member disposed in the accommodation trough of the head with an incline disposed on top of the locating member to contact the tapered surface of the insertion edge on the slide; and the movable jaw is secured at any location on the slide of the head by having both of the tapered surface of the movable jaw and the incline of the locating member to hold against each other.

### BACKGROUND OF THE INVENTION

(a) Field of the Invention

The present invention is related to a hand tool, and more particularly, to an adjustable spanner.

(b) Description of the Prior Art

As illustrate din FIG. 7 of the accompanying drawings, an adjustable spanner 1 of the prior art is comprised of a head 2 and a movable jaw 3. Wherein, a rack 4 is engraved on bottom of the movable jaw 3; a through hole 5 is bored through the head 1 and contains a thumbscrew 6; the thumbscrew 6 and the rack 4 of the movable jaw 3 are connected to each other so that upon turning the thumbscrew, the rack 4 of the movable jaw 3 is synchronously driven for the movable jaw 3 to travel laterally. However, adjusting the location of the movable jaw 3 takes too much time and is comparatively troublesome to fail fast adjustment to a size desired since a user has to dial the thumbscrew to drive and slowly move the rack 4 of the movable jaw 3.

### SUMMARY OF THE INVENTION

The primary purpose of the present invention is to provide an adjustable spanner allowing fast adjustment to a location as desired depending on the specification of a fastener so to correct the problems of lengthy time and inconvenience in the adjustment found with the prior art.

To achieve the purpose, an adjustable spanner of the present invention is essentially comprised of a head, a fixed jaw protrudes from a functioning end of the head, a slide is disposed on a bottom of the fixed jaw, the head contains an accommodation trough, and the accommodation trough connects through the slide; a movable jaw contains an insertion edge corresponding to the slide for the movable jaw to travel on the slide, and a tapered surface is provided to a bottom of the insertion edge; a locating member disposed in the accommodation trough of the head is comprised of a first locating block and a second locating block overlapped on each other, each of both contact surfaces respectively of both locating blocks at where they are overlapped is disposed with a taper for the first locating block to execute a longitudinal placement when held against by the second locating block, an incline is provided on a top of the first locating block, and both of the incline and the tapered surface of the insertion edge contact each other. Accordingly, the movable jaw is fixed at any location on the slide of the head by having the tapered surface of the movable jaw and the incline of the locating member to hold against each other.

### BRIEF DESCRIPTION OF THE DRAWINGS

FIG. 1 is an exploded view of a first preferred embodiment of the present invention.

FIG. 2 is a schematic view of an operating status of the first preferred embodiment of the present invention showing that a movable jaw is located on a slide.

FIG. 3 is a schematic view of another operating status of the first preferred embodiment of the present invention showing a status of free sliding by the movable jaw.

FIG. 4 is an exploded view showing a second preferred embodiment of the present invention.

FIG. 5 is a schematic view of an operating status of the second preferred embodiment of the present invention showing a status of free sliding by a movable jaw.

FIG. 6 is a schematic view of another operating status of the second preferred embodiment of the present invention showing that the movable jaw is located on the slide.

FIG. 7 is a schematic view showing an adjustable spanner of the prior art.

### DETAILED DESCRIPTION OF THE PREFERRED EMBODIMENTS

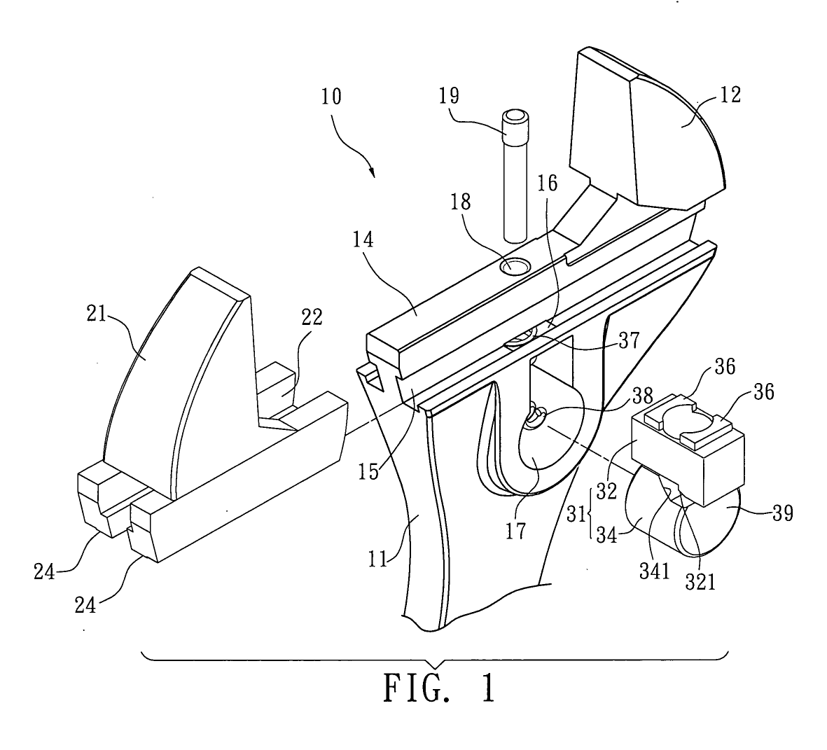

Referring to FIGS. 1, 2, and 3, an adjustable spanner 10 of the present invention is comprised of a head 11, a movable jaw 21, and a locating member 31.

The head 11 has a fixed jaw 12 protruding from a functioning end, and a lateral slide 14 is disposed on a bottom of the fixed jaw 12.

The slide 14 of the head approximately indicates a T shape, and two channels 15 are respectively provided on both sides of the slide 14 and a functioning hole 16 is disposed on each channel 15. An accommodation trough 17 connecting through the channel 15 of the slide 14 via the functioning hole 16 is provided in the head 11.

The movable jaw 21 is provided with an insertion edge 22 corresponding to the slide 14. The insertion edge 22 approximately indicating a C shape inserts onto the slide 14 of the head 11 and is received by both channels 15 for the movable jaw 21 to travel on the slide 14. A tapered surface 24 is provided on a bottom of the insertion edge 22.

The locating member 31 is mounted in the accommodation trough 17 of the head 11. A circular hole 18 penetrates through the slide 14 of the head 11, and a locating post 10 passes through the circular hole 18 to connect to the locating member 31 so to prevent the locating member 31 from falling off the accommodation trough 17 of the head 11. The locating member 31 is comprised of a first locating block 32 and a second locating block 34 overlapped on each other. An incline 36 is provided on a top of the first locating block 32 to contact the tapered surface 24 of the insertion edge 22 on the slide 14 through the functioning hole 16. A taper 321 is disposed on a bottom of the first locating block 32, and another taper 341 is disposed on a top of the second locating block 34 to meet the taper 321 disposed on the bottom of the first locating block 32. A first elastic member 37 is disposed on the first locating block 32 to allow the first locating block 32 a given longitudinal force of return. A second elastic member 38 is disposed on the second locating block 34 to allow the second locating block 34 a given lateral force of return.

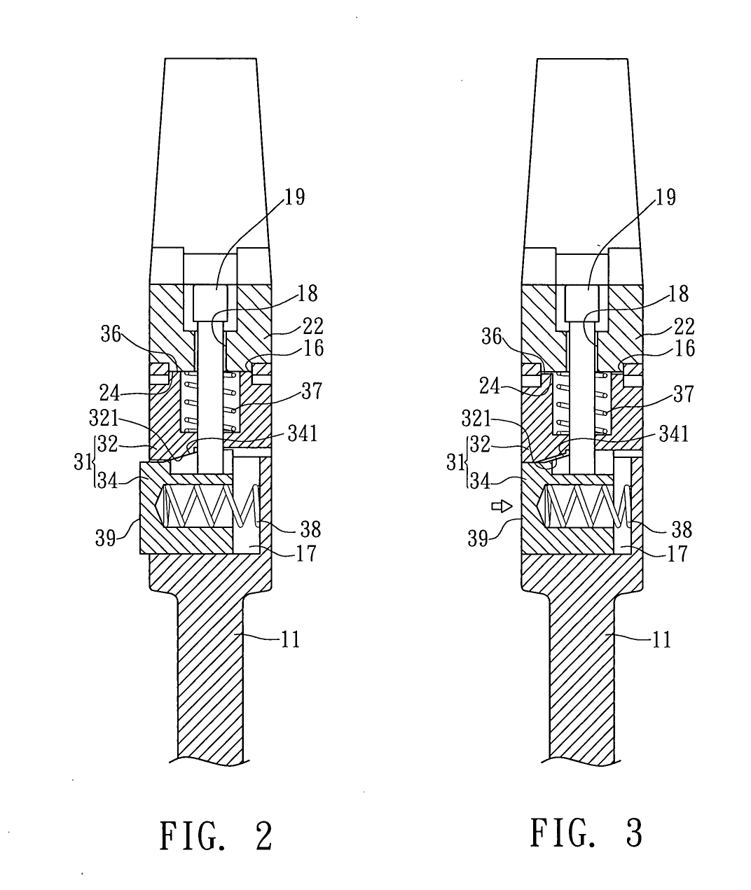

Now referring to FIG. 2, the locating member 31 of the adjustable spanner 10 is mounted in the accommodation trough 17 of the head 11; and the second locating block 34 for being subject to the second elastic member 38 is pushed out so that one end of the second locating block 38 is exposed out of the accommodation trough 17 of the head to form a compression portion 39. Meanwhile, as rejected by the second locating block 34, the first locating block 32 is compressed to cause the first elastic member 37 to move up. Accordingly, the incline 36 on the top of the first locating block 32 passes through the functioning hole 16 on the channel 15 to contact and hold against each other with the tapered surface 24 disposed on the bottom of the movable jaw 21 so to locate the movable jaw 21 in the slide 14.

To adjust location of the movable jaw 21 as illustrate din FIG. 3, the compression portion 39 of the second locating block 34 is directly pressed for the second locating block 34 to move toward inside of the head 11; and with a longitudinal force of return provided by the first elastic member 37, the first locating block 32 is pushed by the first elastic member 37 moves down by means of the design of both tapers 321 and 341. Accordingly, the incline 36 on the top of the first locating block is separated from the tapered surface 24 disposed on the bottom of the movable jaw 21 to engage in free slide before reaching a location desired. Once the location for the movable jaw 21 is decided, the compression portion 39 of the second locating block 34 is released; and the second locating block 34 holds up against the first locating block 32 along both tapers 321 and 341 by means of the force of return provided by the second elastic member 38 so that the incline 36 of the first locating block 32 holds against each other once again the tapered surface 24 of the movable jaw 21 to force the movable jaw 21 to be secured in position. By taking advantage of having both of the tapered surface 24 of the movable jaw 21 and the incline 36 of the locating member 31 to hold against each other, the movable jaw 21 is secured at any location on the slide of the head 11 as desired.

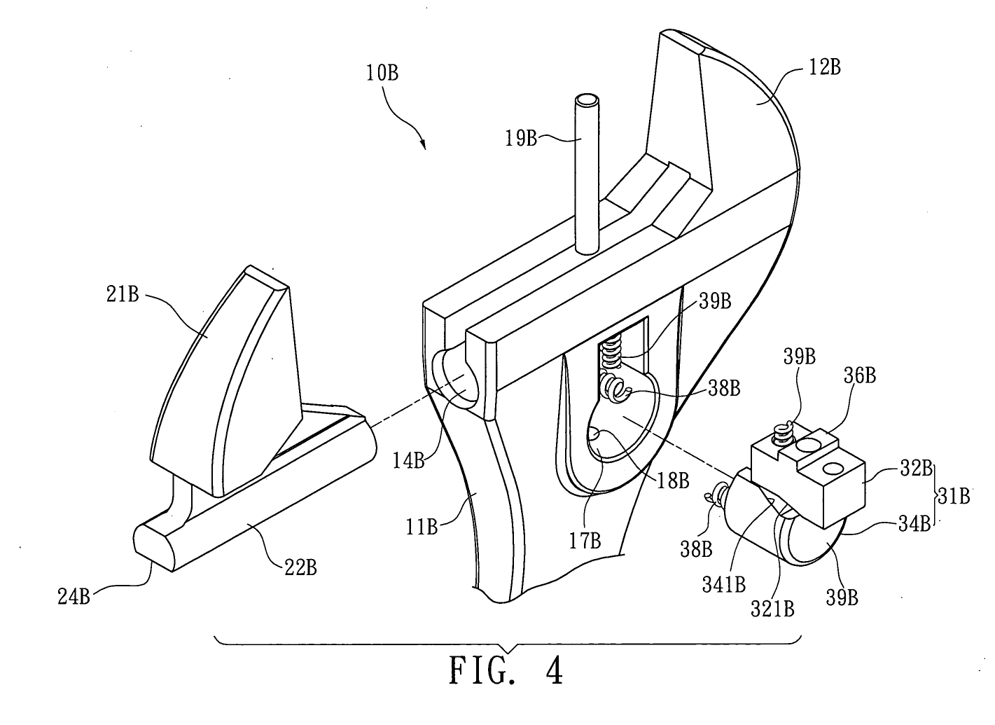

A second preferred embodiment of the present invention as illustrated in FIGS. 4, 5, and 6 is essentially comprised of a head 11B, a movable jaw 21B and a locating member 31B. Wherein the head 11B at its functioning end protruded a fixed jaw 12B; a lateral through hole 14B is disposed on a bottom of the fixed jaw 12B; an accommodation trough 17B is provided in the head 11B; and the accommodation trough 17B is connected through the through hole 14B.

The movable jaw 21B is provided with a slide portion 22B corresponding to an inner diameter of the through hole 14B to allow the slide portion 22B of the movable jaw 21B to slide in the through hole 14B of the head 11B; and a tapered surface 24B is disposed on a bottom of the slide portion 22B.

The locating member 31B is mounted in the accommodation trough 17B of the head 11B; a hole 18B is disposed in the accommodation trough 17B with a locating post 19B penetrating through the hole 18B to connect to the locating member 31B so to hold it in position without escaping from the accommodation trough 17B of the head 11B so that an incline 36B disposed on the top of the locating member 31B contacts each other with the tapered surface 24B disposed on the bottom of the slide portion 22B in the through hole 14B; and the movable jaw 21B is secured at any location in the lateral through hole 14B of the head 11B as desired by having both of the tapered surface 24B of the movable jaw 21B and the incline 36B of the locating member 31B to hold against each other.

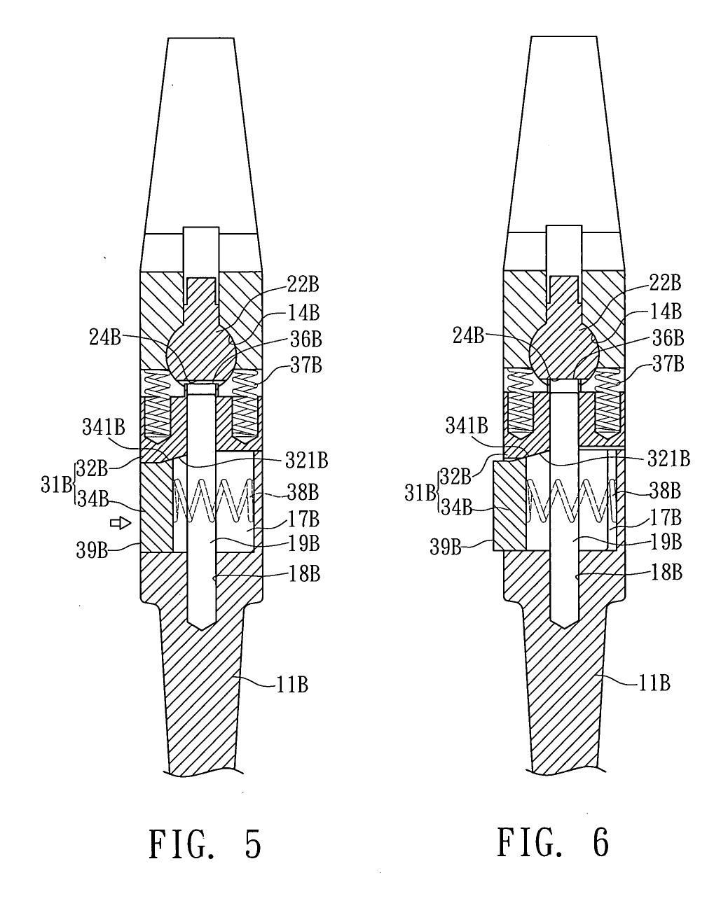

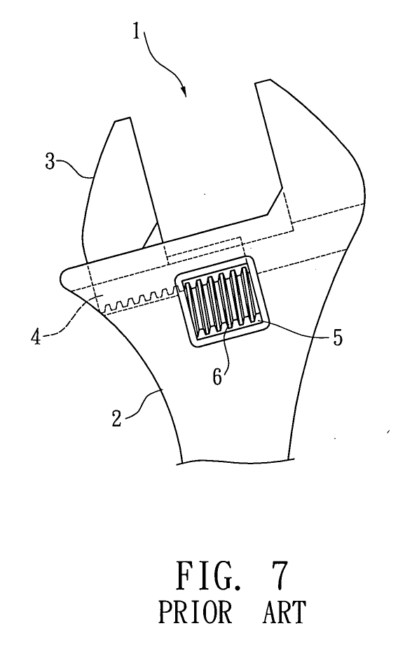

In use, the adjustable spanner 10B as illustrated in FIG. 5, a compression portion 39B of a second locating block 34B is pressed for the second locating block 34B to move toward the inside of the accommodation trough 17B of the head 11B; meanwhile with a longitudinal force of return provided by a first elastic member 37B comprised of a pair of coils in the second preferred embodiment, a first locating block 32B causes both of the first and the second locating blocks 32B, 34B to stick to each other along both tapers 321B and 341B. Therefore, the first locating block 32B is pushed by the first elastic member 37B to move down. Accordingly, the incline 36B of the first locating block 32B is separated from the tapered surface 24B disposed on the bottom of the movable jaw 21B to allow free slide to reach a location as adjusted. Once the location for the movable jaw 21B is decided, the compression 39B of the second locating block 34B is released and as illustrated in FIG. 6 the second locating block 34B pushes up against the first locating block 32B up along both tapers 321B and 341B by applying the force of return provided by a second elastic member 38B comprised of a pair of coils in the second preferred embodiment for the incline 36B of the first locating block 32B to once again hold against each other with the tapered surface 24B of the movable jaw through the lateral through hole 14B once again to force the movable jaw 21B to be secured in position.

apply torque to any type of fastener; and a pattern application for a patent is duly filed accordingly.

I claim:

1. An adjustable spanner comprising:
a head, protruding from its functioning end a fixed jaw, a slide being disposed on a bottom of the fixed jaw; an accommodation trough being disposed in the head, and the accommodation connecting through the slide;
a movable jaw, provided with an insertion edge corresponding to the slide, the movable jaw traveling in the slide of the head, and a tapered surface being disposed on a bottom of the insertion edge; and
a locating member disposed in the accommodation trough of the head and comprised of a first locating block and a second locating block overlapped on each other, a taper being disposed to each of both locating blocks at where they are met; the first locating block being pushed by the second locating block to engage in longitudinal displacement; an incline being disposed on a top of the first locating block; the incline and the tapered surface of the insertion edge contacting each other; and both of the tapered surface of the movable jaw and the tapered surface of the locating member holding against each other to secure the movable jaw at any location in the slide as desired.

2. The adjustable spanner as claimed in claim 1, wherein the head approximately indicates a T shape; two lateral channels are respectively provided on both sides of the slide; the insertion edge of the movable jaw is inserted onto the slide and inset with both channels.

3. The adjustable spanner as claimed in claim 1, wherein a first elastic member is disposed to the first locating block; a longitudinal force of return is provided by the first elastic member to the first locating block; a second elastic member is disposed to the second locating block; and a lateral force of return is provided by the second elastic member to the second locating block.

4. The adjustable spanner as claimed in claim 1, wherein at least one functioning hole is disposed on the slide; the incline of the first locating block and the tapered surface of the movable jaw contact each other through the functioning hole.

5. The adjustable spanner as claimed in claim 1, wherein a circular hole penetrates through the head; a locating post passes through the circular hole to connect to locating block; and the locating block is held in position without escaping from the accommodation trough of the head.

6. An adjustable spanner comprising:
a head having at its functioning end protruded a fixed jaw, a lateral through hole being disposed on a bottom of the fixed jaw;
an accommodation trough connecting through the through hole being disposed in the head;
a movable jaw provided with a slide portion corresponding to the through hole, the slide portion of the movable jaw sliding in the through hole of the head, and a tapered surface being disposed on a bottom of the slide portion;
a locating member disposed in the accommodation trough of the body and comprised of a first locating block and a second locating block overlapped on each other, a taper being disposed to each of both locating blocks at where they meet; the first locating block being pushed by the second locating block to engage in longitudinal displacement; an incline being disposed on a top of the first locating block, the incline and the tapered surface disposed on the bottom of the slide portion contacting each other in the through hole, and the tapered surface of the movable jaw and the incline of the locating member holding against each other to secure the movable jaw at any location in the slide as desired.

7. The adjustable spanner as claimed in claim 6, wherein a first elastic member is disposed to the first locating block; a longitudinal force of return is provided by the first elastic member to the first locating block; a second elastic member is disposed to the second locating block; and a lateral force of return is provided by the second elastic member to the second locating block.

8. The adjustable spanner as claimed in claim 6, wherein a through hole is disposed in the accommodation trough, a locating post passes the through hole to connect to the locating member; and the locating member is confined in the accommodation trough of the head.
